(19) United States
(12) Patent Application Publication
(10) Pub. No.: US 2016/0195652 A1
(43) Pub. Date: Jul. 7, 2016

(54) METHOD OF MANUFACTURING AN OPTICAL FILTERING ELEMENT

(71) Applicant: Opto Optics Corp., Taipei City (TW)

(72) Inventors: Ta-Hsiang Chao, Taipei City (TW); Shih-Hsuan Lin, Taipei City (TW)

(73) Assignee: Opto Optics Corp., Taipei City (TW)

(21) Appl. No.: 14/293,249

(22) Filed: Jun. 2, 2014

(51) Int. Cl. G02B 5/22; G02B 5/26; C03C 17/28; G02B 5/20

(52) U.S. Cl. CPC G02B 5/223; G02B 5/208; G02B 5/26; C03C 17/28

(57) ABSTRACT

A method of manufacturing an optical filtering element includes a preparing step and a layer-forming step. The preparing step comprises preparing a glass material, a red light absorbing material composed of a medium and an organic pigment, and an infrared reflective-layer material composed by two or more materials with different reflectivities stacked with each other. The glass material is cut to form multiple glass substrates. The red light absorbing material is coated on the glass substrates and is heated at 300° C. to form a red light absorbing layer on each glass substrate. The infrared reflective-layer material is coated on the glass substrates to form multiple infrared light reflective layers on each glass substrate.

### BACKGROUND OF THE INVENTION

1. Field of the Invention

The present invention relates to a manufacturing method, and more particularly relates to a method of manufacturing an optical filtering element that can increase the transmittance of the optical filtering element and can absorb visible light with a wavelength ranging from 500 to 900 nanometers to obtain more accurate and uniform colors and to reduce the halo phenomenon of the optical filtering element.

2. Description of Related Art

A wavelength of visible light generally ranges from 400 to 700 nanometers, and the human's eye is more sensitive to light that has a wavelength ranging from 550 to 600 nanometers, i.e. more sensitive to green objects. However, a conventional optical filtering element is either a charge coupled device (CCD) or a complementary metal oxide semiconductor (CMOS), and is more sensitive to red light (600˜700 nm) or near infrared light (700˜1100 nm). Therefore, for designs of associated optical modules such as an optical imaging lens design, the red light or the near infrared light need to be filtered off appropriately to obtain shooting images that can be presented more similar to the human's eye vision. In the industry, a conventional infrared light filter is used to eliminate infrared light that has a wavelength ranging between 700 and 1100 nanometers without eliminating red light that has a wavelength about 650 nanometers, and this will easily enable excessive red light to inject into the conventional infrared light filter to form a glare or a halo phenomenon. Then, the above-mentioned phenomenon will affect the image quality of the optical imaging lens.

In addition, a conventional reflective filter or a conventional absorptive filter is generally used to eliminate light with a specific wavelength. The conventional reflective filter such as an infrared filter is manufactured by coating multiple thin layers of particular materials and thicknesses on a glass substrate. However, the thin layers have different reflection efficiencies for incident lights with different incident angles and different wavelengths, and this will cause the incident lights to generate unstable distributions when the incident lights pass through the conventional reflective filter. Then, the image quality via the conventional reflective filter will be affected.

Furthermore, the conventional absorptive filter is manufactured by adding metal ions such as copper ions into glass (such as phosphoric glass, etc.) to make the conventional absorptive filter have a capacity of absorbing light with a particular wavelength by the metal ions. However, the absorption capacity of the conventional absorptive filter will be reduced with the reduction in the thickness of the glass (Beer-Lambert Law), and this shortcoming is more obviously problematic in the design trends toward thin and compact electronic components. Therefore, the industry has been developing the optical filtering elements that have absorption capacities for lights with specific wavelengths and manufacturing methods thereof.

The present invention provides a method of manufacturing an optical filtering element to mitigate or obviate the aforementioned problems.

### SUMMARY OF THE INVENTION

The main objective of the present invention is to provide a method of manufacturing an optical filtering element that can increase the transmittance of the optical filtering element and can absorb visible light with a wavelength ranging from 500 to 900 nanometers to obtain more accurate and uniform colors and to reduce the halo phenomenon of the optical filtering element.

The method of manufacturing an optical filtering element in accordance with the present invention includes a preparing step and a layer-forming step. The preparing step comprises preparing a glass material, a red light absorbing material being composed of a medium and an organic pigment, and an infrared reflective-layer material being composed by two or more materials with different reflectivities stacked with each other. The glass material is cut to form multiple glass substrates. The red light absorbing material is coated on the glass substrates and is heated at 300° C. to form a red light absorbing layer on each glass substrate. The infrared reflective-layer material is coated on the glass substrates to form multiple infrared light reflective layers on each glass substrate.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a method of manufacturing an optical filtering element in accordance with the present invention;

FIG. 2 is a detailed block diagram of the method of manufacturing an optical filtering element in FIG. 1;

FIG. 3 is an operational side view of forming a red light absorbing layer and multiple infrared light reflective layers on a glass substrate in a layer-forming step of the method of manufacturing an optical filtering element in FIG. 2;

FIG. 4 is another operational side view of forming a red light absorbing layer and multiple infrared light reflective layers on a glass substrate in a layer-forming step of the method of manufacturing an optical filtering element in FIG. 2;

FIG. 5 is further operational side view of forming a red light absorbing layer and multiple infrared light reflective layers on a glass substrate in a layer-forming step of the method of manufacturing an optical filtering element in FIG. 2;

FIG. 6 is further operational side view of forming a red light absorbing layer and multiple infrared light reflective layers on a glass substrate in a layer-forming step of the method of manufacturing an optical filtering element in FIG. 2;

FIG. 7 is further operational side view of forming a red light absorbing layer and multiple infrared light reflective layers on a glass substrate in a layer-forming step of the method of manufacturing an optical filtering element in FIG. 2;

FIG. 8 is an operational side view of forming a UV-resistant layer on the red light absorbing layer in a subsequent-processing step of the method of manufacturing an optical filtering element in FIG. 3;

FIG. 9 is another operational side view of forming a UV-resistant layer on the red light absorbing layer in a subsequent-processing step of the method of manufacturing an optical filtering element in FIG. 7;

FIG. 10 is another operational side view of forming a UV-resistant layer on the red light absorbing layer in a subsequent-processing step of the method of manufacturing an optical filtering element in FIG. 4;

FIG. 11 is another operational side view of forming a UV-resistant layer on the red light absorbing layer in a subsequent-processing step of the method of manufacturing an optical filtering element in FIG. 5; and

FIG. 12 is another operational side view of forming a UV-resistant layer on the red light absorbing layer in a subsequent-processing step of the method of manufacturing an optical filtering element in FIG. 6.

### DETAILED DESCRIPTION OF THE PREFERRED EMBODIMENT

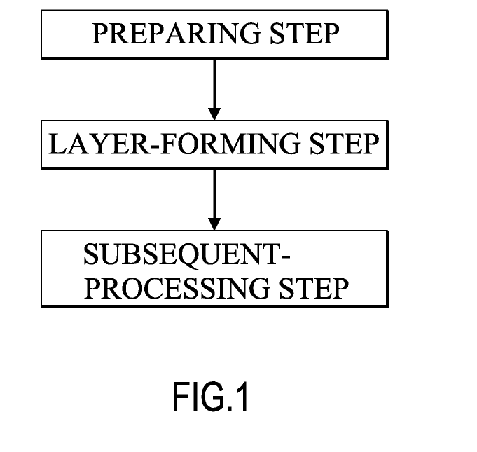

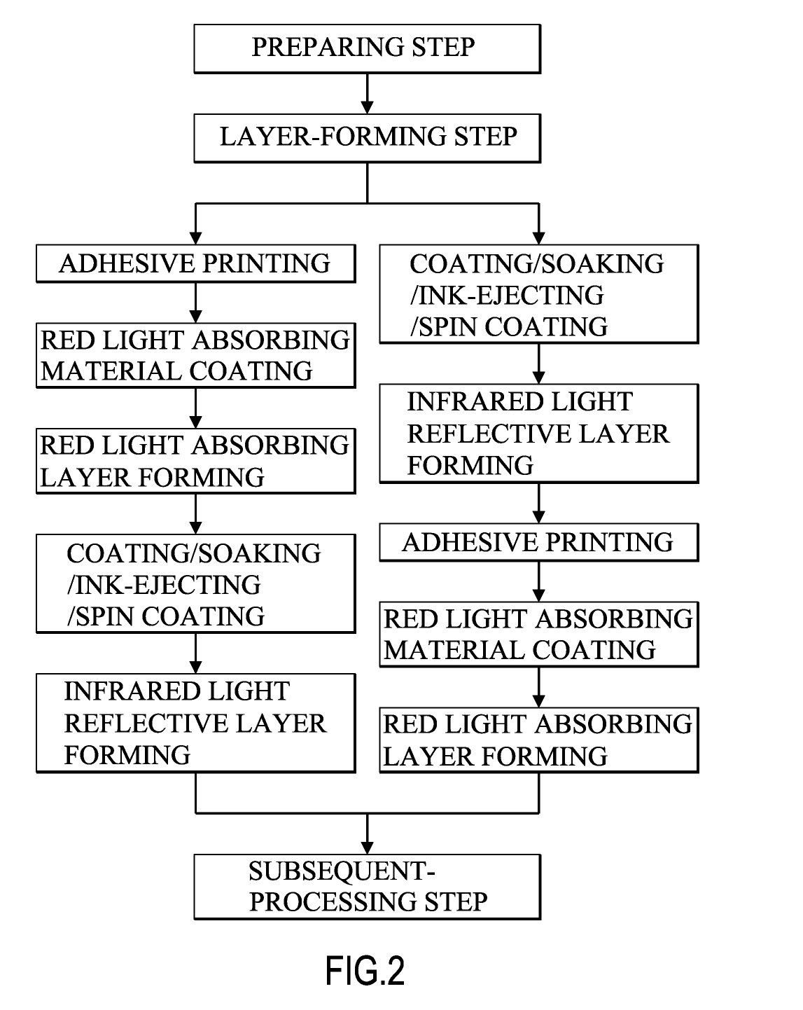

With reference to FIGS. 1 and 2, a method of manufacturing an optical filtering element in accordance with the present invention comprises a preparing step, a layer-forming step, and a subsequent-processing step.

The preparing step comprises preparing a glass material, a red light absorbing material, an infrared reflective-layer material, and a UV-resistant-layer material. The glass material may be 6 inch or 8 inch in diameter, and is cut by a cutting machine to form multiple glass substrates 10. Each one of the glass substrates 10 has a top side and a bottom side. The glass substrates 10 are put into an ultrasound machine for cleaning and drying, wherein the power of the ultrasound machine can be from 300 to 1200 watts (W) and the frequency of the ultrasound machine can be 10 to 200 thousand Hertz (KHz). In addition, a concentration of a cleaning agent that is put in the ultrasound machine is 1% to 10% and the cleaning time of the ultrasound machine is 10 to 300 seconds. Furthermore, the thickness of each one of the glass substrates 10 may be 0.1 millimeters (mm), and the drying temperature is between 10° C. and 85° C.

The red light absorbing material is composed of a medium and an organic pigment. The medium is a surface-active agent (also called surfactant) and is used to reduce the surface tension between two liquids or between a liquid and a solid, the surface active agent may be an organic compound that is composed of carbon, hydrogen, nitrogen, sulfur, halogen and phosphorus. Preferably, the surface active agent is polyvinyl alcohol. The organic pigment may be Phthalocyanine, Cyanine, Diimmonium or Squarylium. The concentration of the organic pigment is between 0.1% and 20%.

The infrared reflective-layer material is composed by two or more materials with different reflectivities stacked with each other. In addition, the material and the thickness of the red light absorbing material are well known in the art and are not further elaborated in the specification. The UV-resistant-layer material is formed by a material that can resist UV light, and the material and thickness of the UV-resistant-layer material are well known in the art and are not further elaborated in this specification.

The layer-forming step comprises forming a red light absorbing layer 20 and multiple infrared light reflective layers 30 on each glass substrate 10 after cleaning and drying the glass substrates 10. With reference to FIG. 2, there are two ways of forming the red light absorbing layer 20 and the infrared light reflective layers 30 on the glass substrate 10.

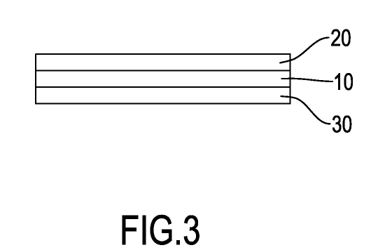

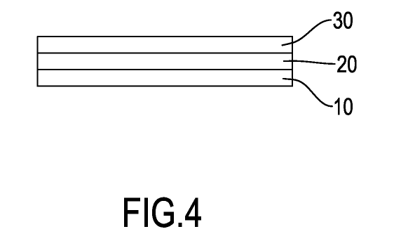

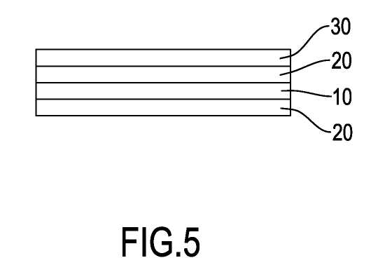

In the first way, an adhesive is printed on at least one of the surfaces of the glass substrate 10. Preferably, with reference to FIGS. 3 and 4, the adhesive is printed on the top surface of the glass substrate 10. In addition, with reference to FIG. 5, the adhesive is printed on the top surface and the bottom surface of the glass substrate 10 simultaneously. The red light absorbing material is coated on the adhesive above the top surface of the glass substrate 10 to form the red light absorbing layer 20 as shown in FIGS. 3 and 4 or is coated on the adhesives respectively above the top surface and the bottom surface of the glass substrate 10 to form the two red light absorbing layers 20 as shown in FIG. 5.

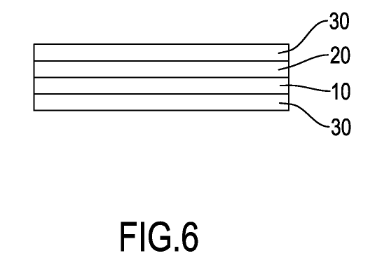

Preferably, after the adhesive is printed on the at least one of the surfaces of the glass substrate 10, the glass substrate 10 is put on a turntable of a spin coater and is rotated at a rotating speed of 500 to 8000 RPM for 10 to 300 seconds, and the red light absorbing material is dropped and coated on the adhesive or the adhesives uniformly by multiple droppers that are mounted in the spin coater above the turntable. After the red light absorbing material is coated on the adhesive or the adhesives uniformly, the glass substrate 10 is put in an oven and is heated at 300° C. for 10 to 10800 seconds to form the red light absorbing layer 20 or to form the two red light absorbing layers 20. Each one of the red light absorbing layers 20 will not be thermally decomposed below 400° C. and have an absorbing capacity for light that has a wavelength ranging from 500 to 900 nanometers. In addition, the thickness of each one of the red light absorbing layers 20 may be between 0.1 to 5 micrometers, and the thicknesses of the glass substrate and the red light absorbing layers 20 can be adjusted according to the user's need. Preferably, when each one of the red light absorbing layers 20 is formed on the glass substrate 10, the glass substrate 10 is put into the ultrasound machine for cleaning and drying. After cleaning and drying the glass substrate 10, the infrared reflective-layer material is coated or soaked or ink-ejected or spin-coated on a bottom surface of the glass substrate 10 as shown in FIG. 3 or on one of the red light absorbing layers 20 as shown in FIGS. 4 and 5 or on the red light absorbing layer 20 and the glass substrate 10 simultaneously shown in FIG. 6 to form the infrared light reflective layers 30.

Then, with reference to FIG. 3, the red light absorbing layer 20 is formed on the top surface of the glass substrate 10 and the infrared light reflective layers 30 are formed on the bottom surface of the glass substrate 10 to form an optical filtering element in accordance with the present invention. In addition, with reference to FIG. 4, the infrared light reflective layers 30 are formed on the red light absorbing layer 20 opposite to the glass substrate 10 to form an optical filtering element in accordance with the present invention. Preferably, before the infrared light reflective layers 30 are formed on the red light absorbing layer 20 as shown in FIG. 4, the adhesive is printed on the red light absorbing layer 20. Furthermore, with reference to FIG. 5, the infrared light reflective layers 30 are formed on the uppermost red light absorbing layer 20 opposite to the glass substrate 10 and the lowermost red light absorbing layer 20 to form an optical filtering element in accordance with the present invention. Additionally, with reference to FIG. 6, the infrared light reflective layers 30 are formed on the red light absorbing layer 20 and the bottom surface of the glass substrate 10 simultaneously to an optical filtering element in accordance with the present invention.

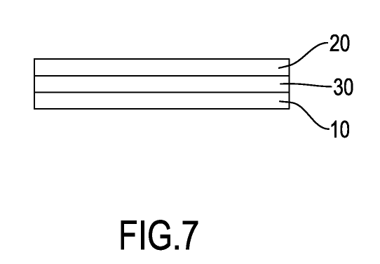

In the second way, with reference to FIG. 7, the infrared reflective-layer material is coated or soaked or ink-ejected or spin-coated on the top surface of the glass substrate 10 to form the infrared light reflective layers 30, and the adhesive is printed on an uppermost one of the infrared light reflective layers 30 that is opposite to the glass substrate 10. Then, the red light absorbing material is coated on the adhesive uniformly to form the red light absorbing layer 20. Preferably, the red light absorbing material can be coated on the adhesive uniformly by putting the glass substrate 10 in the spin coater. Additionally, after coating the red light absorbing material uniformly on the adhesive, the glass substrate 10 is put in the oven and is heated at 300° C. for 10 to 10800 seconds to form the red light absorbing layer 20. Then, with reference to FIG. 7, the red light absorbing layer 20 and the glass substrate 10 are formed beside the infrared light reflective layers 30 to form an optical filtering element in accordance with the present invention.

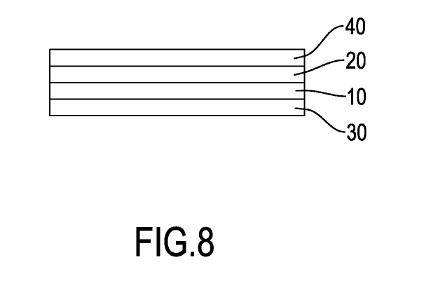

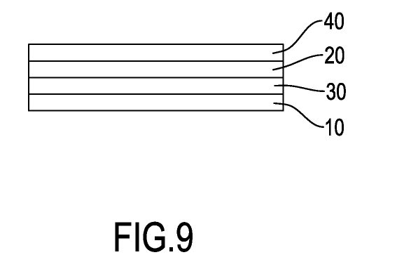

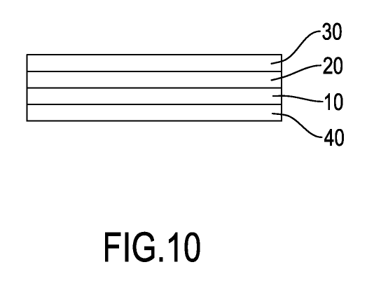

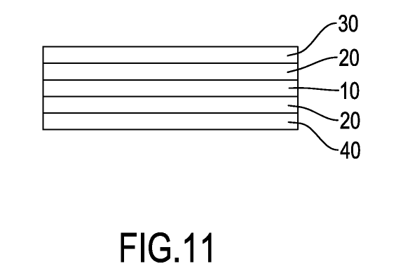

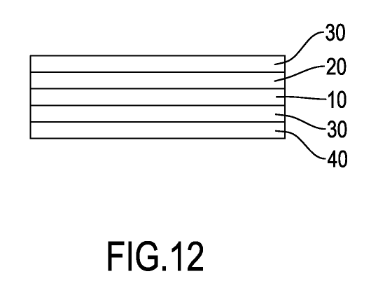

The subsequent-processing step comprises putting the glass substrate 10 in the ultrasound machine for cleaning and drying after the red light absorbing layer 20 and the infrared light reflective layers 30 are formed on the glass substrate 10, inspecting the glass substrate 10 after cleaning and drying the glass substrate 10 to find defects of the glass substrate 10, and coating the UV-resistant-layer material on the glass substrate 10 to form a UV-resistant layer 40 as shown in FIGS. 8 to 12. With reference to FIGS. 3 and 8, the UV-resistant-layer material is coated on the red light absorbing layer 20 opposite to the infrared light reflective layers 30 to form the UV-resistant layer 40. With reference to FIGS. 7 and 9, the UV-resistant-layer material is coated on the red light absorbing layer 20 opposite to the glass substrate 10 to form the UV-resistant layer 40. With reference to FIGS. 4 and 10, the UV-resistant-layer material is coated on the glass substrate 10 opposite to the infrared light reflective layers 30 to form the UV-resistant layer 40. With reference to FIGS. 5 and 11, the UV-resistant-layer material is coated on the lowermost red light absorbing layer 20 opposite to the infrared light reflective layers 30 to form the UV-resistant layer 40. With reference to FIGS. 6 and 12, the UV-resistant-layer material is coated on the lowermost infrared light reflective layers 30 opposite to the uppermost infrared light reflective layers 30 to form the UV-resistant layer 40.

In addition, when inspecting the glass substrate 10, a strong light of 1000 to 3000 Lux is irradiated on the glass substrate 10 at different angles from 0 to 360 degrees to inspect the undesired defects of the glass substrate 10 such as scratches, fractures, or dirt on the surfaces of the glass substrate 10. In operation, when using the first way to form the red light absorbing layer 20 and the infrared light reflective layers 30 on the glass substrates 10, the amount of the infrared light reflective layers 30 is more than the amount of the red light absorbing layer 20 such that time consumed for forming the infrared light reflective layers 30 is more than forming the red light absorbing layer 20. Therefore, forming the red light absorbing layer 20 is arranged in a sequence prior to forming the infrared light reflective layers 30, and this can reduce the loss when the forming of the infrared light reflective layers 30 fails. Additionally, the infrared light reflective layers 30 are coated on the glass substrate 10 at a temperature between 100° C. to 350° C., and the red light absorbing layer 20 will not be thermally decomposed below 400° C., and this can prevent the red light absorbing layer 20 from thermally decomposing when the infrared light reflective layers 30 are coated on the glass substrate 10. Then, the time and cost of forming the red light absorbing layer 20 on the glass substrate 10 can be saved.

Furthermore, when using the second way to form the red light absorbing layer 20 and the infrared light reflective layers 30 on the glass substrates 10, due to the flatness requirement of the infrared light reflective layers 30 is stricter than the flatness requirement of the red light absorbing layer 20 and the glass substrate 10 has a flatness higher than any of the layers 20, 30, the infrared light reflective layers 30 are formed on the glass substrate 10 firstly and then the red light absorbing layer 20 is formed on the infrared light reflective layers 30, and this can improve the yield of manufacturing the optical filtering element in accordance with the present invention.

According to the above-mentioned features, by the two ways, the red light absorbing layer 20 can be formed on the glass substrate 10 or the infrared light reflective layers 30 to form the optical filtering element in accordance with the present invention. The optical filtering element can absorb the infrared light in a light source to reduce the chromatic aberration caused by the excessive red light and to increase light transmittance (93%) of the optical filtering element, thereby the color of the image is more accurate and uniform. In addition, the optical filtering element also can absorb refracting light in the light source to reduce the halo phenomenon and lower the angle-dependence of the optical filtering element, and the optical filtering element is made thinner without decreasing the absorption rate of the optical filtering element.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of manufacturing an optical filtering element comprising:
a preparing step comprising:
preparing a glass material, a red light absorbing material being composed of a medium and an organic pigment, and an infrared reflective-layer material being composed by two or more materials with different reflectivities stacked with each other; and
cutting the glass material to form multiple glass substrates; and
a layer-forming step comprising:
coating the red light absorbing material on the glass substrates;
heating the red light absorbing material at 300° C. to form at least one red light absorbing layer on each glass substrate;
coating the infrared reflective-layer material on the glass substrates to form multiple infrared light reflective layers on each glass substrate; and
wherein the red light absorbing layer is thermally indecomposable below 400° C. and has an absorbing capacity for light with a wavelength ranging from 500 to 900 nanometers.

2. The method of manufacturing an optical filtering element as claimed in claim 1, wherein
the preparing step comprises preparing a UV-resistant-layer material that is formed by a material that can resist UV light;
the method of manufacturing an optical filtering element comprises a subsequent-processing step after the layer-forming step; and
the subsequent-processing step comprises coating the UV-resistant-layer material on the glass substrate that has formed the at least one red light absorbing layer and the infrared light reflective layers to form a UV-resistant layer.

3. The method of manufacturing an optical filtering element as claimed in claim 1, wherein the red light absorbing material is Phthalocyanine, Cyanine, Diimmonium or Squarylium.

4. The method of manufacturing an optical filtering element as claimed in claim 3, wherein the layer-forming step comprises
printing an adhesive on a top surface of each glass substrate;
coating the red light absorbing material on the adhesive above the top surface of each glass substrate;
putting and heating the glass substrates in an oven after the red light absorbing material is coated on the adhesive uniformly to form the al least one red light absorbing layer on each glass substrate;
coating the infrared reflective-layer material on a bottom surface of each glass substrate to form the infrared light reflective layers after the red light absorbing layer is formed on the top surface of each glass substrate to enable the at least one red light absorbing layer and the infrared light reflective layers to form beside the glass substrate.

5. The method of manufacturing an optical filtering element as claimed in claim 4, wherein the layer-forming step comprises
putting the glass substrates on a turntable of a spin coater after the adhesive is printed on the top surface of each glass substrate;
rotating the glass substrates at a rotating speed of 500 to 8000 RPM for 10 to 300 seconds after the adhesive is printed on the top surface of each glass substrate; and
dropping and coating the red light absorbing material on the adhesive uniformly by multiple droppers that are mounted in the spin coater above the turntable.

6. The method of manufacturing an optical filtering element as claimed in claim 5, wherein the layer-forming step comprises putting the glass substrates into an ultrasound machine for cleaning and drying after the at least one red light absorbing layer is formed on the top surface of each glass substrate; and
coating the infrared reflective-layer material on the bottom surface of each glass substrate to form the infrared light reflective layers after cleaning and drying the glass substrates.

7. The method of manufacturing an optical filtering element as claimed in claim 6, wherein the subsequent-processing step comprises coating the UV-resistant-layer material on each glass substrate to form a UV-resistant layer on the at least one red light absorbing layer after inspecting each glass substrate to find defects of the glass substrate.

8. The method of manufacturing an optical filtering element as claimed in claim 3, wherein the layer-forming step comprises
printing an adhesive on a top surface and a bottom surface of each glass substrate;
coating the red light absorbing material on the adhesives respectively above the top surface and the bottom surface of each glass substrate;
putting each glass substrate in an oven to form two red light absorbing layers beside the glass substrate; and
coating the infrared reflective-layer material on one of the red light absorbing layers of each glass substrate to form multiple infrared light reflective layers.

9. The method of manufacturing an optical filtering element as claimed in claim 8, wherein the layer-forming step comprises
putting the glass substrates on a turntable of a spin coater after the adhesive is printed on the top surface and the bottom surface of each glass substrate;
rotating the glass substrates at a rotating speed of 500 to 8000 RPM for 10 to 300 seconds after the adhesive is printed on the top surface and the bottom surface of each glass substrate; and
dropping and coating the red light absorbing material on the adhesives uniformly by multiple droppers that are mounted in the spin coater above the turntable.

10. The method of manufacturing an optical filtering element as claimed in claim 9, wherein the layer-forming step comprises
putting the glass substrates into an ultrasound machine for cleaning and drying after the red light absorbing layers are respectively formed on the top surface and the bottom surface of each glass substrate; and
coating the infrared reflective-layer material on one of the red light absorbing layers to form the infrared light reflective layers after cleaning and drying the glass substrates.

11. The method of manufacturing an optical filtering element as claimed in claim 10, wherein the subsequent-processing step comprises coating the UV-resistant-layer material on each glass substrate to form a UV-resistant layer on the glass substrate after inspecting each glass substrate to find defects of the glass substrate.

12. The method of manufacturing an optical filtering element as claimed in claim 3, wherein the layer-forming step comprises
printing an adhesive on one of a top surface and a bottom surface of each glass substrate;
coating the red light absorbing material on the adhesive above the corresponding surface of each glass substrate;
putting each glass substrate in an oven to form the red light absorbing layer on the corresponding surface of the glass substrate; and
coating the infrared reflective-layer material on the red light absorbing layer and the other surface of each glass substrate to form multiple infrared light reflective layers to enable the infrared light reflective layers to form beside the glass substrate and the red light absorbing layer.

13. The method of manufacturing an optical filtering element as claimed in claim 12, wherein the layer-forming step comprises
putting the glass substrates on a turntable of a spin coater after the adhesive is printed on the corresponding surface of each glass substrate;
rotating the glass substrates at a rotating speed of 500 to 8000 RPM for 10 to 300 seconds after the adhesive is printed on the corresponding surface of each glass substrate; and
dropping and coating the red light absorbing material on the adhesive uniformly by multiple droppers that are mounted in the spin coater above the turntable.

14. The method of manufacturing an optical filtering element as claimed in claim 13, wherein the layer-forming step comprises
putting the glass substrates into an ultrasound machine for cleaning and drying after the red light absorbing layer is formed on the corresponding surface of each glass substrate; and
coating the infrared reflective-layer material on the red light absorbing layer and the other surface of the glass substrate to form the infrared light reflective layers after cleaning and drying the glass substrates.

15. The method of manufacturing an optical filtering element as claimed in claim 14, wherein the subsequent-processing step comprises coating the UV-resistant-layer material on the red light absorbing layer of each glass substrate to form a UV-resistant layer on the glass substrate after inspecting each glass substrate to find defects of the glass substrate.

16. The method of manufacturing an optical filtering element as claimed in claim 3, wherein the layer-forming step comprises
coating the infrared reflective-layer material on one of a top surface and a bottom of each glass substrate to form multiple infrared reflective-layers on the corresponding surface of the glass substrate;
printing an adhesive on an uppermost one of the infrared light reflective layers that is opposite to the glass substrate;
coating the red light absorbing material on the adhesive above the uppermost one of the infrared light reflective layers;
putting each glass substrate in an oven to form the red light absorbing layer on the uppermost one of the infrared light reflective layers to enable the red light absorbing layer and the glass substrate to form beside the infrared light reflective layers.

17. The method of manufacturing an optical filtering element as claimed in claim 16, wherein the layer-forming step comprises
putting the glass substrates on a turntable of a spin coater after the adhesive is printed on the uppermost one of the infrared light reflective layers of each glass substrate;
rotating the glass substrates at a rotating speed of 500 to 8000 RPM for 10 to 300 seconds after the adhesive is printed on the uppermost one of the infrared light reflective layers of each glass substrate; and
dropping and coating the red light absorbing material on the adhesive uniformly by multiple droppers that are mounted in the spin coater above the turntable.

18. The method of manufacturing an optical filtering element as claimed in claim 17, wherein the subsequent-processing step comprises coating the UV-resistant-layer material on the red light absorbing layer of each glass substrate to form a UV-resistant layer on the glass substrate after inspecting each glass substrate to find defects of the glass substrate.

19. The method of manufacturing an optical filtering element as claimed in claim 3, wherein the preparing step comprises putting the glass substrates into an ultrasound machine for cleaning and drying after cutting.

20. The method of manufacturing an optical filtering element as claimed in claim 2, wherein the subsequent-processing step comprises
putting the glass substrates in an ultrasound machine for cleaning and drying before the UV-resistant-layer material is coated on the red light absorbing layer 20 of each glass substrate; and
inspecting the glass substrates after cleaning and drying the glass substrates to find defects of the glass substrates.
